(19) United States
(12) Patent Application Publication
(10) Pub. No.: US 2003/0233356 A1
(43) Pub. Date: Dec. 18, 2003

(54) User interface for facilitating interaction between a user and an information system

(76) Inventors: Christopher James Dean, Brooksville, FL (US); Jeffrey Erin Graham, Cocoa, FL (US); Jody Lee Roberts, Plano, TX (US)

Correspondence Address: CARR LAW FIRM, L.L.P., 670 FOUNDERS SQUARE, 900 JACKSON STREET, DALLAS, TX, 75202, US

(21) Appl. No.: 10/217,054

(22) Filed: Aug. 12, 2002

Related U.S. Application Data
(63) Continuation-in-part of application No. 10/171,916, filed on Jun. 14, 2002.

(51) Int. Cl. G06F 7/00

(52) U.S. Cl. 707/4

(57) ABSTRACT

A user interface and method are provided to facilitate interaction between a user and an information system. The user interface retrieves a domain model from the information system. The user interface also receives one or more user inputs from the user. Based on the domain model and the one or more user inputs, the user interface creates a query, and transmits the query to the information system for processing. Subsequently, the user interface receives one or more query results from the information system. The one or more query results correspond to the query. The user interface displays the one or more query results.

### RELATED APPLICATIONS

The present application is a continuation-in-part of U.S. patent application Ser. No. 10/171,916, SYSTEM AND METHOD FOR RETRIEVING INFORMATION FROM DISPARATE INFORMATION SOURCES AND INTEGRATING THE INFORMATION IN ACCORDANCE WITH A DOMAIN MODEL, Christopher James Dean, filed Jun. 14, 2002.

### BACKGROUND OF THE INVENTION

1. Field of the Invention

The invention relates generally to accessing information and, more particularly, to a user interface for accessing information.

2. Description of the Related Art

The development of computer systems and computer networks has made it feasible to access information located in a local or remote computer system. The advent of the Internet, for example, enables a user of a computer system to access information stored in a local or remote computer system through various Internet protocols such as Transmission Control Protocol/Internet Protocol (TCP/IP) and HyperText Transport Protocol (HTTP). The World Wide Web (WWW) is one phenomenal example of using the Internet to remotely access information.

Specifically, the WWW is an Internet service that links documents locally and remotely. Documents are stored on the Internet in web servers that store and disseminate web pages. Typically, a user accesses web pages with software called a web browser. The web page, or web document, contains text, graphics, animations and videos as well as hypertext links. The links in the page let users jump from page to page through the HTTP protocol whether the pages are stored on the same server or on servers around the world.

There are also many local networks reserved for private entities or government agencies to share information within such entities or agencies. More and more of these local networks use the HTTP protocol or similar hypertext protocols to make their own information available within the entities or agencies. Such a local network may be collectively called an intranet.

On either the Internet or an intranet, browsing through web pages is a popular way in which a user accesses information. Web pages typically include hypertext links, which relate one piece of information to another. However, such hypertext links are not necessarily based on meaningful relations between different pieces of information. Therefore, accessing information through hypertext links is often a laborious and time consuming process. Moreover, typical hypertext links leave the task of integrating pieces of information to a user, because such links would merely lead the user to another web page. Sometimes, the information sought by a user may not be readily available from a single web page. Instead, the information may be obtained only by integrating different pieces of information available from different web pages.

Therefore, there is a need for a user interface for enabling a user to access information in a timely fashion and providing the user with an integrated view of the information.

### SUMMARY OF THE INVENTION

A user interface and method are provided to facilitate interaction between a user and an information system. The user interface retrieves a domain model from the information system. The user interface also receives one or more user inputs from the user. Based on the domain model and the one or more user inputs, the user interface creates a query, and transmits the query to the information system for processing. Subsequently, the user interface receives one or more query results from the information system. The one or more query results correspond to the query. The user interface displays the one or more query results.

### BRIEF DESCRIPTION OF THE DRAWINGS

For a more complete understanding of the present invention and the advantages thereof, reference is now made to the following descriptions taken in conjunction with the accompanying drawings, in which:

FIG. 1A is a block diagram illustrating an information system according to the present invention;

FIG. 1B is a block diagram illustrating the information system of FIG. 1A further including a security agent;

FIG. 2 is a block diagram illustrating an expanded information system according to the present invention;

FIG. 3 is a flow diagram illustrating the operation of the information system according to the present invention;

FIG. 4 is a high-level flow diagram illustrating the operation of the user interface of the information system according to the present invention; and

FIG. 5 is a low-level flow diagram illustrating the operation of the user interface of the information system according to the present invention.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

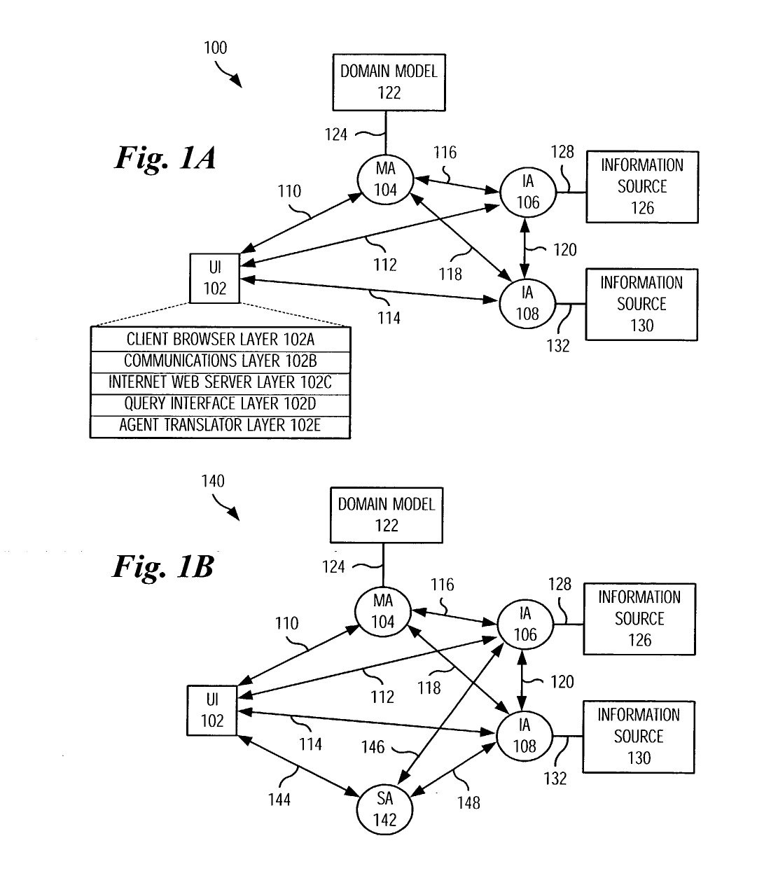

In FIG. 1A, a reference numeral 100 generally designates an information system according to the present invention. The information system 100 includes a user interface 102, model agent 104, a first integration agent 106, and a second integration agent 108. The user interface 102 is in communication with the model agent 104 through a communication link 110. The user interface 102 is also in communication with the first integration agent 106 and the second integration agent 108 through communication links 112 and 114, respectively. The model agent 104 is in communication with the first integration agent 106 and the second integration agent 108 through communication links 116 and 118, respectively. The first integration agent 106 is in communication with the second integration agent 108 through a communication link 120.

The user interface 102 is a software program installed in a user computer system (not shown). Specifically, the user interface 102 collectively represents all interface programs between a user (not shown) of the information system 100 and various software agents such as the model agent 104 and the first and second integration agents 106 and 108. Specifically, the user interface 102 includes a client browser layer 102A (e.g., a web browser), a communications layer 102B (e.g., TCP/IP), an Internet web server layer 102C (e.g., IIS, Apache, NES, etc), a query interface layer 102D (e.g., ColdFusion), and an agent translator layer 102E (e.g., ColdFusion custom tags).

Typically, the user interacts with the client browser layer 102A and is insulated from the detailed operation of the other four layers of the user interface 102. In other words, the client browser layer 102A is closest to the user in the hierarchy within the user interface 102.

The model agent 104, the first integration agent 106, and the second integration agent 108 are role-based software agents. Preferably, the model agent 104, the first integration agent 106, and the second integration agent 108 are installed in the user computer system. Alternatively, the model agent 104, the first integration agent 106, and the second integration agent 108 are installed in any of computer systems (not shown) in a network (not shown) including the user computer system. The network may have either wired or wireless connections between the computer systems. That is, the communication links 110, 112, 114, 116, 118, and 120 each are based upon either a wired physical link or a wireless physical link. For example, the user computer system having the user interface 102 may be a laptop computer or a handheld computer such as a personal digital assistant (PDA), whereas the other computer systems having such software agents may be connected through wired links (not shown). In this example, the communication links 110, 112, and 114 are based upon wireless physical links, whereas the communication links 116, 118, and 120 are based upon wired physical links.

The model agent 104 has access to a domain model 122 through a communication link 124. Preferably, the model agent 104 is installed in a computer system (not shown) that has access to a storage device (not shown) such as a hard disk, a floppy disk, CD-ROM, and RAM. The storage device may be either internal or external to the computer system. In this case, the communication link 124 includes a data bus (not shown) connecting the computer system and the storage device. Alternatively, the model agent 104 is installed in a computer system (not shown) that is connected to another computer system (not shown) having access to such a storage device. In both of these configurations, the storage device contains the domain model 122. Preferably, the computer system supports Java platform.

The first integration agent 106 has access to a first information source 126 through a communication link 128. Similarly, the second integration agent 108 has access to a second information source 130 through a communication link 132. The first and second information sources 126 and 130 each contain structured data and/or unstructured data. Optionally, the information system 100 can have one or more additional integration agents (not shown) depending on the network configuration of the information system 100.

Preferably, the user interface 102 maintains a copy of the domain model received from the model agent 104, and the user interface 102 receives model updates from the model agent 104 through the communication link 110. For example, the user interface 102 maintains a listener (not shown) that listens for model updates from the model agent 104. This way, the user interface 102 maintains a current domain model in real-time, as the integration agents 106 and 108 publish model updates to the model agent 104.

The first and second integration agents 106 and 108 publish publication information (not shown) to the model agent 104. The publication information includes information on which portion of the domain model 122 each of the first and second integration agents 106 and 108 has access to. The model agent 104 provides the publication information to the first and second integration agents 106 and 108 such that the first and second integration agents 106 and 108 share the publication information among themselves through the model agent 104.

The user interface 102 receives one or more user inputs (not shown), and creates a query (not shown) based upon the one or more user inputs and the domain model 122. Preferably, the domain model 122 includes a plurality of classes (not shown) and one or more relations (not shown) among the plurality of classes. In this case, each class has one or more attributes. Preferably, the one or more user inputs are used to select at least a first class. The first class has a first set of one or more attributes. The one or more user inputs are also used to assign one or more keywords to the first set of one or more attributes. Preferably, the one or more keywords include one or more query criteria (e.g., strings, integers, floating point numbers, etc.).

The user interface 102 determines which of the first and second integration agents 106 and 108 to send the query to. Preferably, this determination is based upon the publication information received from the model agent 104. For example, if the query requires a query result available from the first information source 126 in whole or in part, then the publication information provided by the first integration agent 106 indicates that the query result is available from the first information source 126. Thus, the user interface 102 determines that the query should be sent to the first integration agent 106 in order to access the first information source 126. Alternatively, a user may specify a particular integration agent to which the query is initially sent.

Assuming that the query is initially sent to the first integration agent 106, the first integration agent 106 processes the query based upon the publication information provided by the model agent 104. Note that this publication information may also include the publication information from the second integration agent 108. First, the first integration agent 106 determines whether one or more sub-queries should be created from the query. If a single integration agent can fully process the query, then sub-queries need not be created from the query. For example, if the first information source 126 contains all query results corresponding to the query, then the first integration agent 106 can fully process the query without the help of the second integration agent 108. In this example, sub-queries need not be created from the query.

If, however, two or more integration agents are required to fully process the query, then sub-queries should be created from the query. For example, if the query requires first and second sub-query results, wherein the first sub-query result is available from the first information source 126 and the second sub-query result is available from the second information source 130, then the first integration agent 106 cannot fully process the query without the help of the second integration agent 108. In this case, first and second sub-queries need be created from the query. Assuming that the first and second sub-queries require the first and second sub-query results, respectively, the first sub-query should be handled by the first integration agent 106 and the second sub-query should be sent to the second integration agent 108. The first integration agent 106 processes the first sub-query and retrieves the first sub-query result from the first information source 126. Similarly, the second integration agent 108 processes the second sub-query and retrieves the second sub-query result from the second information source 130. The second integration agent 108 then sends the second sub-query result to the first integration agent 106. Subsequently, the first integration agent 106 integrates the first and second sub-query results and creates a query result corresponding to the query.

In either of these examples, the first integration agent 106 sends the query result to the user interface.

Typically, the data formats used by the first and second information sources 126 and 130 may be different than the data format of the domain model 122. Generally, the first and second integration agents 106 and 108 perform value mappings on data coming from the first and second information sources 126 and 130 (e.g., convert TEXAS to TX and vice-versa), transformations on values (e.g., converting phone numbers to different back-end formats) and function conversions (e.g., miles to kilometers and vice-versa) on values.

There are various kinds of integration agents including Java DataBase Connectivity (JDBC), document, and email integration agents. In a preferred embodiment, however, JDBC integration agent configurations are used for the first and second integration agents 106 and 108. A JDBC integration agent maps model classes and attributes to their corresponding one or more tables and columns. For example, the JDBC integration agent maps a model class to one or more structured query language (SQL) tables. These mappings can use any native SQL that can be placed in a SELECT clause and thus can concatenate fields, perform sub-strings, etc. Such a JDBC integration agent will also automatically convert between model types and back-end information source types. For example, if a given attribute of type STRING and the information source type is a DECIMAL, the JDBC integration agent will put in the necessary logic to convert the information into a proper form. The JDBC integration agent can also combine backend tables together to form a single enterprise model class.

Although the information system 100 is shown to include only the first and second integration agents 106 and 108, additional integration agents (not shown) may be added to the information system 100 without departing from the true spirit of the present invention. Such additional integration agents will have the same interactions with other components of the information system 100 as the first and second integration agents 106 and 108 each have.

Now referring to FIG 1B, a reference numeral 140 designates another information system including the information system 100 of FIG. 1A and a security agent 142. The security agent 142 is in communication with the user interface 102 through a communication link 144. Similarly, the security agent 142 is in communication with the first and second integration agents 106 and 108 through communication links 146 and 148, respectively. The security agent 142 is connected to a security database (not shown), which defines the users and their roles. Preferably, for each registered user, the security database contains user identification, a password, and a set of roles. The security agent 142 controls access to the roles assigned to users of the system. The roles restrict access to classes and attributes in the domain model 122 to users with the same corresponding roles. Preferably, the security agent provides the roles to the first and second integration agents 106 and 108 so that the first and second integration agents 106 and 108 evaluates the user's role(s) against requested classes and attributes in the query. If the role(s) have insufficient rights to access the requested classes and attributes specified in the query, any of the first and second integration agents 106 and 108 deny access. Alternatively, the security agent 142 evaluates each query received from the user interface 102 and evaluates the user's role(s) against requested classes and attributes in the query. If the role(s) have insufficient rights to access the requested classes and attributes specified in the query, the security agent 142 denies access.

Although the information system 140 is shown to include only the first and second integration agents 106 and 108, additional integration agents (not shown) may be added to the information system 140 without departing from the true spirit of the present invention. Such additional integration agents will have the same interactions with other components of the information system 140 as the first and second integration agents 106 and 108 each have.

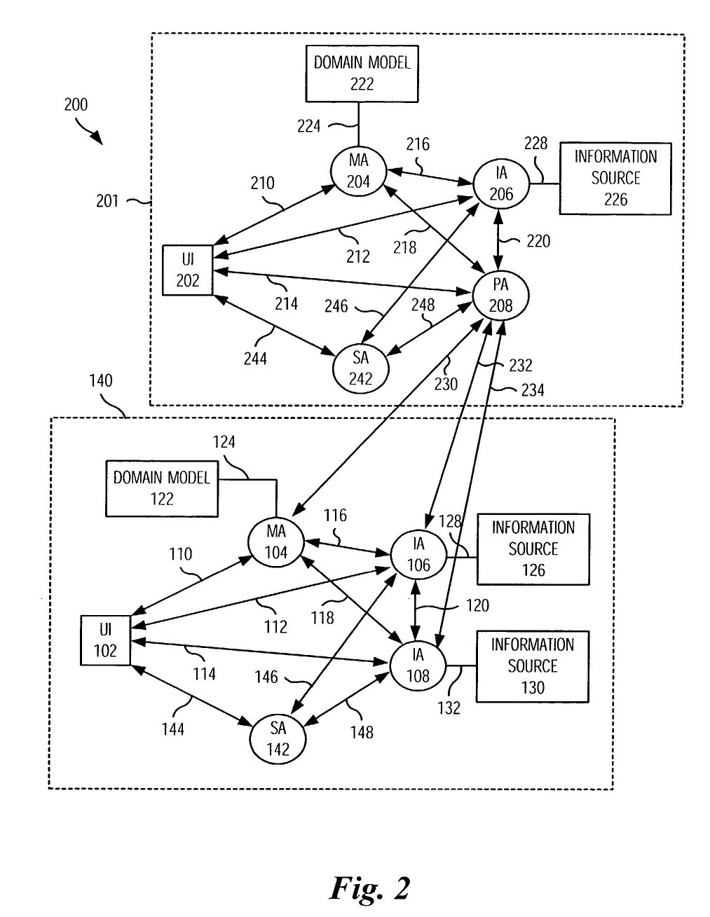

Now referring to FIG. 2, an expanded information system 200 includes the information system 140 of FIG. 1 and a similar information system 201 in communication with the information system 150. Similarly to the information system 140, the information system 201 includes a user interface 202, model agent 204, a third integration agent 206, and a proxy integration agent 208. The user interface 202 is in communication with the model agent 204 through a communication link 210. The user interface 202 is also in communication with the third integration agent 206 and the proxy integration agent 208 through communication links 212 and 214, respectively. The model agent 204 is in communication with the third integration agent 206 and the proxy integration agent 208 through communication links 216 and 218, respectively. The third integration agent 206 is in communication with the proxy integration agent 208 through a communication link 220.

The user interface 202 is a software program installed in a user computer system (not shown). The model agent 204, the third integration agent 206, and the proxy integration agent 208 are role-based software agents. Preferably, the model agent 204, the third integration agent 206, and the proxy integration agent 208 are installed in the user computer system. Alternatively, the model agent 204, the third integration agent 206, and the proxy integration agent 208 are installed in any of computer systems (not shown) in a network (not shown) including the user computer system. The network may have either wired or wireless connections between the computer systems. That is, the communication links 210, 212, 214, 216, 218, and 220 each are based upon either a wired physical link or a wireless physical link. For example, the user computer system having the user interface 202 may be a laptop computer or a handheld computer such as a personal digital assistant (PDA), whereas the other computer systems having such software agents may be connected through wired links (not shown). In this example, the communication links 210, 212, and 214 are based upon wireless physical links, whereas the communication links 216, 218, and 220 are based upon wired physical links.

The model agent 204 has access to a domain model 222 through a communication link 224. Preferably, the model agent 204 is installed in a computer system (not shown) that has access to a storage device (not shown) such as a hard disk, a floppy disk, CD-ROM, and RAM. The storage device may be either internal or external to the computer system. In this case, the communication link 224 includes a data bus (not shown) connecting the computer system and the storage device. Alternatively, the model agent 204 is installed in a computer system (not shown) that is connected to another computer system (not shown) having access to such a storage device. In both of these configurations, the storage device contains the domain model 222.

The third integration agent 206 has access to a third information source 226 through a communication link 228. The proxy integration agent 208 is in communication with the model agent 104 through a communication link 230. Also, the proxy integration agent 208 has access to the first and second information sources 126 and 130 through communication links 232 and 234, respectively. The third information source 226 contains structured data and/or unstructured data. Optionally, the information system 201 can have one or more additional integration agents (not shown) depending on the network configuration of the information system 201.

The information system 201 further includes a security agent 242, which is in communication with the user interface 202 through a communication link 244. Similarly, the security agent 242 is also in communication with the third integration agent 206 and the proxy integration agent 208 through communication links 246 and 248, respectively. The security agent 242 is similarly configured to the security agent 142.

The operation of the information system 201 is generally similar to that of the information system 140 except for the operation of the proxy integration agent 208. Generally, when integration agents are used in a hierarchical approach having a regional setup (e.g., the information system 201) and a local setup (e.g., the information system 105), a proxy integration agent such as the proxy integration agent 208 is used, especially when firewalls are involved between the regional setup and the local setup. Specifically, the model agent 104 of the information system 140 publishes its subset of some higher global model to the information system 201. At the information system 201, the proxy integration agent 208 publishes this subset to the information system 201. The user interface 202 at the information system 201 can then access data at the information system 150 by querying the proxy integration agent 208, which pass the query onto the local integration agents such as the first and second integration agents 106 and 108. Preferably, the proxy integration agent 208 acts just like the integration agent 206 at the information system 201 and acts just like the user interface 102 at the information system 150. The proxy integration agent 208 acts as a pure pass-through or performs all the same mappings that a standard integration agent such as the third integration agent 206 can.

Although the information system 201 is shown to include only the third integration agent 206, additional integration agents (not shown) may be added to the information system 201 without departing from the true spirit of the present invention. Such additional integration agents will have the same interactions with other components of the information system 201 as the third integration agent 206 has.

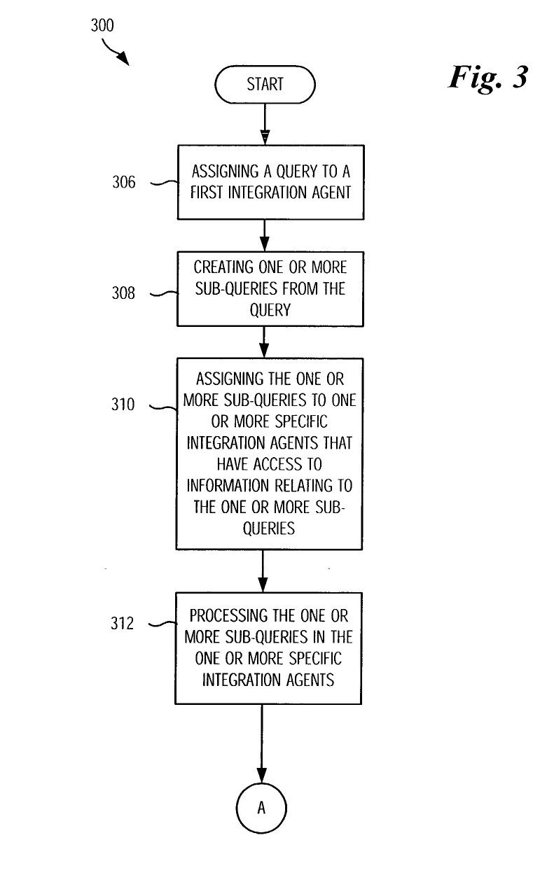

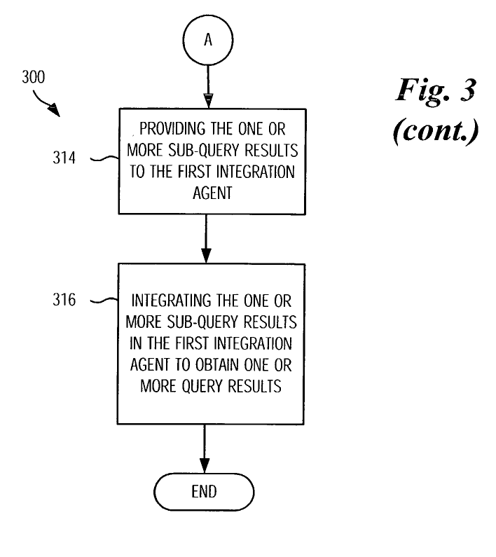

In FIG. 3, a flow diagram 300 depicts a high-level operation of the present invention. The flow diagram 300 will be described in reference to the information system 100 of FIG. 1A; however, the flow diagram 300 is also applicable similarly configured information system according to the present invention.

In step 306, a query is assigned to a first integration agent. In the information system 100, the user interface 102 assigns the query to the first integration agent 106. In step 308, one or more sub-queries are created from the query. If in step 308 no sub-query is created, then empty result is returned. However, in step 308, it is assumed that at least one sub-query is created for subsequent steps to be executed. In the information system 100, the first integration agent 106 creates the one or more sub-queries from the query.

In step 310, the one or more sub-queries are assigned to one or more specific integration agents that have access to information relating to the one or more sub-queries. In the information system 100, the first integration agent 106 assigns the one or more sub-queries to the one or more specific integration agents. For example, if the one or more sub-queries are available only from the first information source 126, the first integration agent 106 assigns the one or more sub-queries to the first integration agent 106 itself. If the one or more sub-queries are available only from the second information source 130, the first integration agent 106 assigns the one or more sub-queries to the second integration agent 108. If first and second sub-queries of the one or more sub-queries require access to the first and second information sources 126 and 130, respectively, then the first integration agent 106 assigns the first and second sub-queries to the first and second integration agents 106 and 108, respectively.

In step 312, the one or more sub-queries are processed in the one or more specific integration agents. In the information system 100 of FIG. 1, for example, at least one of the first and second integration agents processes the one or more sub-queries. Specifically, if the one or more sub-queries are available only from the first information source 126, the first integration agent 106 processes the one or more sub-queries. If the one or more sub-queries are available only from the second information source 130, the second integration agent 106 processes the one or more sub-queries. If first and second sub-queries of the one or more sub-queries require access to the first and second information sources 126 and 130, respectively, then the first and second integration agents 106 and 108 process the first and second sub-queries, respectively.

Optionally, each of the one or more sub-queries is evaluated to determine whether a particular sub-query is a base query. A base query is defined herein as a query including a class having one or more sub-classes under the class. For example, a bird class has many sub-classes including bluebirds, robins, doves, sparrows, etc. When a user queries a base query including the bird class, the user may want to get results from all sub-classes such as a bluebird class, a robin class, and a dove class. In that case, the specific integration agent handling the base query can first perform the query for each sub-class under the base query and then combine the results. Preferably, a domain model includes information on the number and kind of sub-classes under a base query.

In step 314, the one or more specific integration agents provide the one or more sub-query results to the first integration agent. In step 316, the one or more sub-query results are integrated in the first integration agent to obtain one or more query results corresponding to the query.

As shown in the flow diagram 300 in general and in steps 306, 310, 314, and 316 in particular, the present invention provides peer-to-peer architecture among a plurality of integration agents. This peer-to-peer architecture has numerous advantages over conventional agent-based information systems. For example, there is no single point of failure, because any one of the plurality of integration agents may assume the role of the first integration agent as in steps 306, 310, 314, and 316.

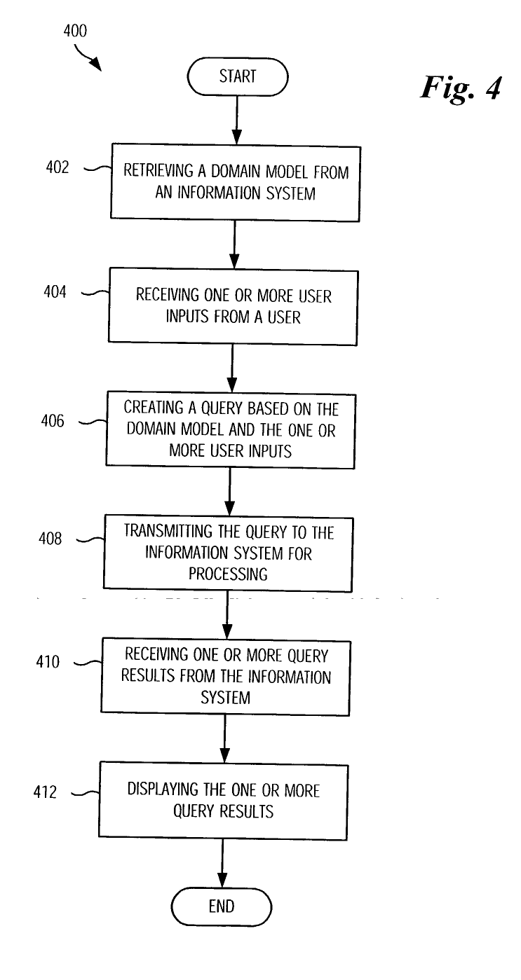

Now referring to FIG. 4, a high-level flow diagram 400 depicts a preferred operation of a user interface in an information system according to the present invention.

In step 402, a domain model is retrieved from an information system. Preferably, the domain model is retrieved from a model agent of the information system. Specifically, the domain model includes a plurality of classes, one or more relations between the plurality of classes, and one or more attributes for each of the plurality of classes.

In step 404, one or more user inputs are received from a user. The one or more user inputs may be received at different times during the interaction between the user and the information system. For example, a first user input may be used to select a class from the plurality of classes, and a second user input may be used to enter one or more values, if any, for the one or more attributes of the selected class.

In step 406, a query is created based upon the domain model and the one or more user inputs. Specifically, the query includes information on the one or more attributes of the selected class and the one or more values for the one or more attributes. Preferably, the query may be described in knowledge query language (KQL). In that case, the query includes a SELECT clause matching the one or more attributes of the selected class and a WHERE clause including the one or more values for the one or more attributes.

In step 408, the query is transmitted to the information system for processing. Preferably, the query is transmitted to an integration agent of the information system.

In step 410, one or more query results are received from the information system. The one or more query results correspond to the query. Preferably, the one or more query results are received from the integration agent.

In step 412, the one or more query results are displayed so that the user may review the query results. Specifically, the user may either continue or terminate the process depending on the query results.

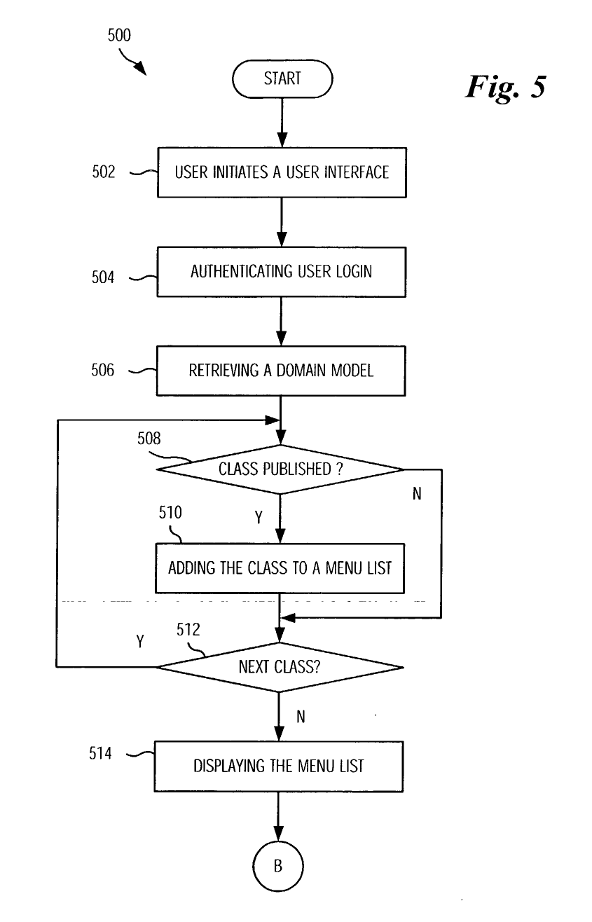

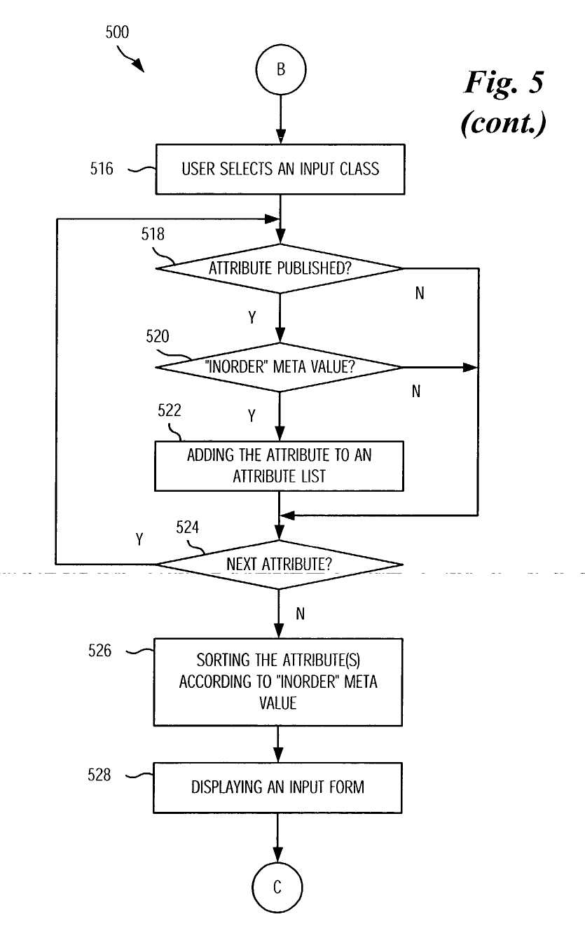

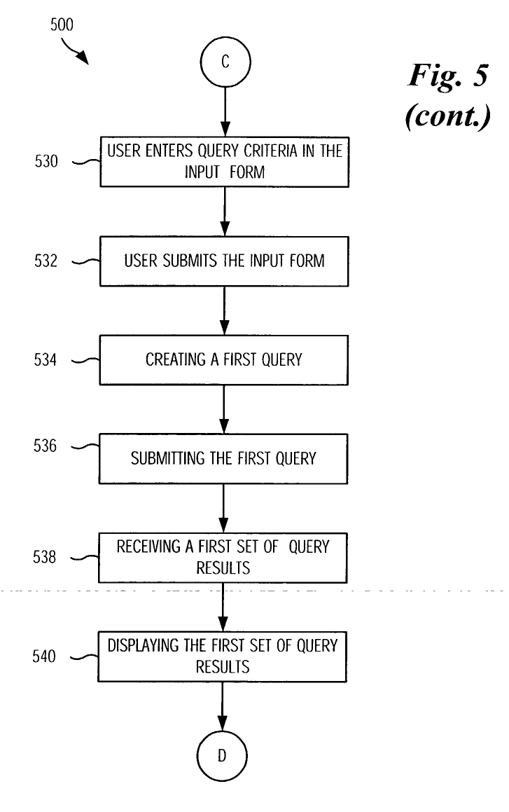

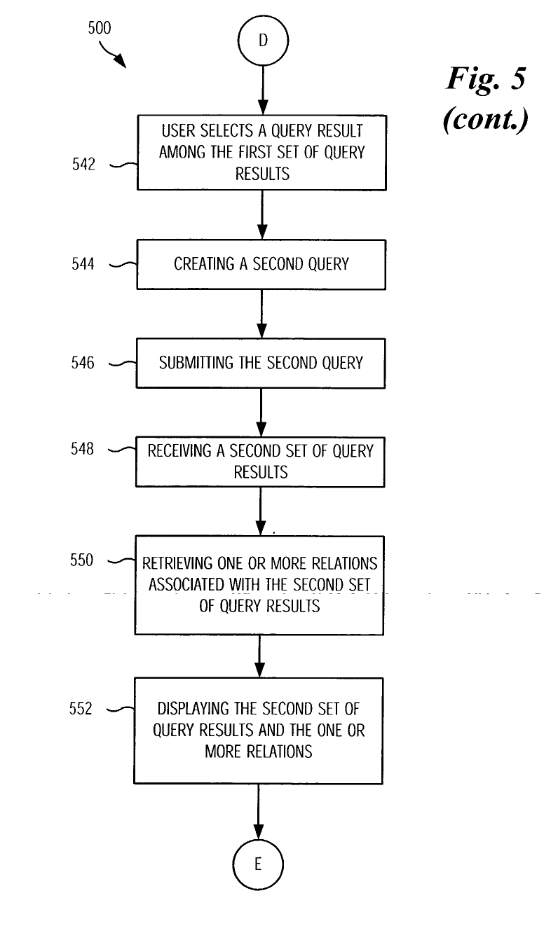

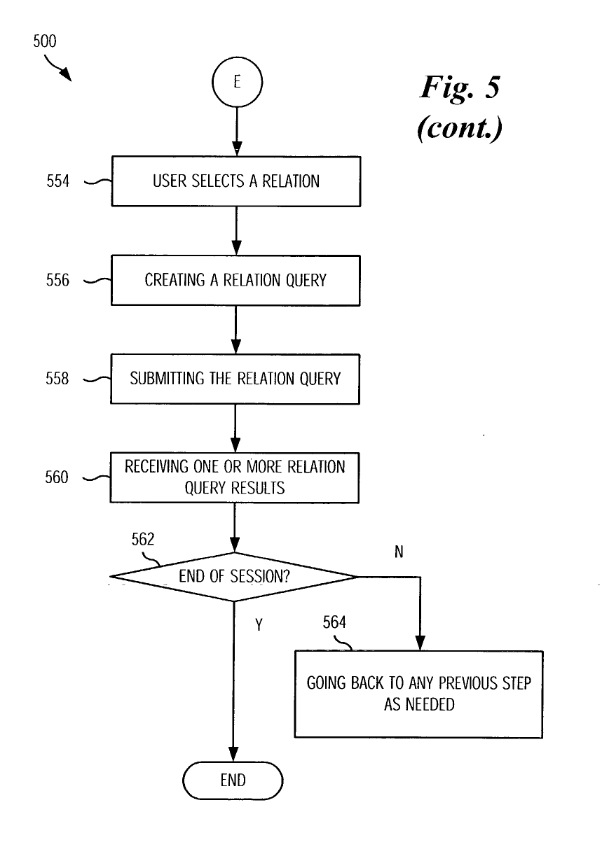

Now referring to FIG. 5, a low-level flow diagram 400 depicts a preferred operation of a user interface in an information system according to the present invention.

To facilitate the understanding of the present invention, a consistent example will be used to explain each step of the flow diagram 500. In this example, the information system is a data integration system for law enforcement officers, and enables a user (e.g., an investigator or a police officer) authorized to use the information system to seek a piece of information (e.g., information on a perpetrator) using another piece of information (e.g., an anonymous tip).

In step 502, a user initiates a user interface. Preferably, the user interface includes a browser such as the client browser layer 102A of FIG. 1. For example, the client browser layer 120A includes an HTTP browser running on a user computer system (not shown). In this example, the user starts the HTTP browser and accesses an assigned URL.

In step 504, the user interface authenticates the user for a user login. Preferably, the user interface displays a login frame. The user interface must authenticate the user in order for the user to access the information system. Typically, the user has to enter his or her user ID and a password. However, other authentication schemes may be used. No action may be taken before the authentication occurs. Preferably, the user enters his or her user ID and a password, and the user interface authenticates the information against a user database provided by a security agent such as the security agent 142 of FIG. 1B. The user database contains information on the role(s) of the user, which role(s) dictate the range of classes and attributes the user may be allowed to access. If the user ID and password are valid, the user interface proceeds to an operational mode.

In step 506, the user interface retrieves the domain model of the information system. Typically, step 506 is performed upon a system startup. Alternatively or optionally, step 506 is performed at a user's request through the user interface. Preferably, the user interface makes a call to retrieve the domain model via ColdFusion custom tags. For example, the initialization tag name may be <RIDE_INITIALIZE>.

In step 508, it is determined whether a class is published. A class is defined as “published” if the class has at least one published attribute. If the class is published, then the process goes to step 510. If not, the process skips step 510 and goes to step 512. In step 510, the class is added to a menu list. In step 512, it is determined whether there is a next class to evaluate. If there is another class to evaluate, then the process goes back to step 508. If there is no additional class to evaluate, then the process goes to step 514.

In step 514, the menu list is displayed. The menu list includes one or more published classes. In effect, only classes that have at least one published attribute are displayed. This way, the user cannot select a class that will not return any information. Specifically, the menu list is a hierarchy of classes that resembles the inheritance organization of the domain model. Preferably, the menu list may be implemented in a menu tree.

Let us assume that the user here is an investigator. The user starts by searching for events where the police responded to a certain type of call in a certain location. The user's anonymous tip indicates that shots had been heard on Redbud Street, so the officer enters “shots fired” in the call description field, and “Redbud” in the location field. Preferably, the results are displayed in a quick scan list (not shown) showing all the calls for service where shots were fired on Redbud Street.

In step 516, an input class is selected among the one or more published classes. Preferably, the user selects an input class from the menu list.

In step 518, it is determined whether an attribute of a published class is published. If the attribute is published, the process goes to step 520, wherein it is determined whether the attribute has an “INORDER” meta value. The “INORDER” meta value is one of several meta values in the domain model that can be attached to an attribute. It provides sorting information that allows the user interface to display input attributes in a more controlled manner. If the attribute is published and has an “INORDER” meta value, then the process goes to step 522, wherein the attribute is added to the menu list. Other meta values include “OUTORDER,” “HIDDEN_IN,” and “HIDDEN_OUT,” which provides information respectively on whether an attribute is outputted, whether an attribute is hidden in input fields, and whether an attribute is hidden in output fields.

In step 524, it is determined whether there is a next attribute to evaluate. If there is another attribute to evaluate, then the process goes back to step 518. If there is no additional attribute to evaluate, then the process goes to step 526. In step 526, the attribute(s) are sorted according to the “INORDER” meta values attached to the attribute(s). In step 528, an input form is displayed to show the sorted attribute(s).

In step 530, the user enters query criteria in the input form. When the user submits values in search fields, the user interface evaluates the submitted attributes. In step 532, the user submits the input form.

In step 534, the user interface creates a first query. As described in reference to step 406 of FIG. 4, the query includes information on one or more attributes and one or more search values corresponding to the one or more attributes. Preferably, the query may be described in knowledge query language (KQL). In that case, the query contains a SELECT clause matching the one or more attributes and a WHERE clause including the one or more search values.

In step 536, the first query is submitted to the information system. Preferably, the first query is submitted to an integration agent of the information system such as the first integration agent 106 of FIG. 1.

In step 538, the user interface receives a first set of query results. Preferably, the user interface receives the first set of query results from an integration agent such as the first integration agent 106 of FIG. 1. The first set of query results has at least a result class.

In step 540, the first set of query results is displayed. Preferably, the first set of query results is displayed in a quick scan list in tabular format. The quick scan list only shows title attributes (i.e., attributes that provide meaningful information and allow the record to be distinguished from other records). The user may choose to terminate here or hit a detail button to see all the attributes. Specifically, each sub-query may be displayed in a separate table according to the subclass name. Preferably, each record may have a link, which will read either “View” or “NFI”. The “View” button allows a more detailed query of that specific record. The “NFI” indicates that information was retrieved, but no further information is available. In another preferred embodiment, the “View” button is not displayed instead of having the “NFI” button, if no further information is available.

In step 542, the user selects a query result among the first set of query results. Generally, the user selects the query result to view more information than is displayed in the title attributes and possibly any relations to the information later on. In the law enforcement example, the investigator views the records and selects one of them, remembering a comment about a parking lot and a Holiday Inn.

In step 544, a second query is created. The second query includes a SELECT clause containing every attribute in the class that is being published, and a WHERE clause containing one or more unique identifier attributes. The one or more unique identifier attributes hold unique keys, matching the value found in the record in the quick scan list. This has the net effect of limiting the query result to one record, provided that the keys mapped to the field(s) of unique identifier attributes are truly unique. The integration agents allow for multiple columns in a back-end data source to form the key, in the event that no single column is unique within a table.

In step 546, the second query is submitted. Preferably, the second query is submitted to an integration agent.

In step 548, a second set of query results is received.

In step 550, the user interface retrieves relations. Preferably, the user interface retrieves one or more relations associated with the second set of query results. Preferably, the relations are displayed as relation description and enabled as a hypertext link. Therefore, the user can follow the relation by clicking on the link.

In step 552, the user interface displays the second set of query results received in step 548 and the one or more relations retrieved in step 550. Preferably, the user interface displays object details of the second set of query results and any relations associated with the object details.

In step 554, the user selects a relation among the one or more relations retrieved in step 550. For example, the user views the second set of query results (e.g., object details) and selects an object detail, remembering a comment about a parking lot. Another query is constructed, with a SELECT clause containing every attribute in the class that is being published, and a WHERE clause containing one or more key attributes, matching the value found in the record in the quick scan list, and the criteria necessary to link the domain instance to the range instance(s) such as in the relation “Person owns Vehicle” WHERE Person.driver_license_number=Vehicle.Owner_license_number and Person.driver_license_number=12345.

The first integration agent allows for multiple columns in a back-end information source to form the key, in the event that no single column is unique within a table, so it is theoretically possible to derive a unique key in almost any information source, unless a database contained the same information in every record.

In step 556, a relation query is created based upon the relation selected in step 554. When the user follows the relation, the user interface creates a query with the SELECT clause containing the attributes of the class on the range side of the relation that would be displayed in the quick scan list for that class. For example, in the relation “Person owns Vehicle,” the domain-side class would be “Person”, the relation description would be “owns”, and the range-side class would be “Vehicle”. The attributes of the classes are contained in the relation but hidden from the user. Relation descriptions may include the attribute name or other helpful information that would aid the user in the understanding of the nature of the relation. The FROM clause would be the object class on the range side of the relation, being displayed in the detail area, and the WHERE clause would contain the attribute comparisons. For example, in the relation “Person owns Vehicle”, the WHERE clause could look like “WHERE Person.driver_license_number=Vehicle.Owner_license_number”. In our example case, the user decides to ask the person who took the call, a dispatcher, if she remembers anything about the call.

In step 558, the relation query is submitted. Preferably, the relation query is submitted to an integration agent.

In step 560, one or more relation-query results are received and displayed as a quick scan list. For example, in the relation “Person owns Vehicle”, a Person object displayed in the detail area would create a quick scan list with a vehicle, or vehicles, if the person owns more than one vehicle. In our case, by following the relation for the call's taker, the individual is revealed. By opening a detail of the record, a phone number allows the officer to call and question the dispatcher. The dispatcher may be unable to offer anything helpful, or may point the investigator in the right direction. The investigator could go back and follow other relations, or back up further and alter the search criteria, or start a new search in a new class.

In step 562, it is determined whether the current search to session is ended. If not, the process goes to step 564, wherein the user may go back to any previous step to continue the search as needed.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A method for facilitating interaction between a user and an information system, the method comprising the steps of:
(a) retrieving a domain model from the information system;
(b) receiving one or more user inputs from the user;
(c) creating a query based on the domain model and the one or more user inputs;
(d) transmitting the query to the information system for processing; and
(e) receiving one or more query results from the information system, the one or more query results corresponding to the query.

2. The method of claim 1, further comprising the steps of:
(a) authenticating the user for logging on the information system; and
(b) displaying the one or more query results.

3. The method of claim 1, wherein the domain model has a plurality of classes and one or more relations among the plurality of classes, and wherein each of the plurality of classes has one or more attributes.

4. A method for facilitating interaction between a user and an information system, the method comprising the steps of:
(a) retrieving a domain model from the information system, wherein the domain model has a plurality of classes;
(b) selecting an input class from the plurality of classes, the input class having one or more attributes;
(c) assigning one or more values to the one or more attributes;
(d) creating a first query from the one or more attributes and the one or more values;
(e) submitting the first query to the information system for processing;
(f) receiving a first set of query results from the information system, the first set of query results corresponding to the first query; and
(g) displaying the first set of query results.

5. The method of claim 4, further comprising the steps of:
(a) selecting a query result among the first set of query results;
(b) creating a second query based on the query result;
(c) submitting the second query to the information system;
(d) receiving a second set of query results from the information system, the second set of query results corresponding to the second query;
(e) retrieving one or more relations associated with the second set of query results; and
(f) displaying the second set of query results and the one or more relations.

6. The method of claim 5, further comprising the steps of:
(a) selecting a relation among the one or more relations;
(b) creating a relation query from the relation;
(c) submitting the relation query to the information system; and
(d) receiving one or more relation-query results from the information system.

7. The method of claim 4, further comprising the steps of:
(a) authenticating the user for logging on the information system;
(b) determining whether a class of the plurality of classes is published;
(c) upon determination that the class of the plurality of classes is published, adding the class to a menu list;
(d) repeating the steps of determining and adding for all of the plurality of classes; and
(e) displaying the menu list.

8. The method of claim 7, wherein the menu list includes a hierarchy of classes that resembles an inheritance organization of the domain model.

9. The method of claim 4, further comprising the steps of:
(a) determining whether an attribute of the one or more attributes is published and whether the attribute of the one or more attributes includes a meta value providing sorting information;
(b) upon determination that the attribute of the one or more attributes is published and that the attribute of the one or more attributes includes the meta value, adding the attribute to the menu list;
(c) repeating the steps of determining and adding for all of the one or more attributes;
(d) sorting the one or more attributes according to the meta value; and
(e) displaying an input form including the one or more attributes.

10. The method of claim 9, wherein the step of assigning one or more values to the one or more attributes is performed by entering input criteria in the input form, the method further comprising the step of submitting the input form.

11. A user interface for facilitating interaction between a user and an information system, the user interface comprising:
(a) means for retrieving a domain model from the information system;
(b) means for receiving one or more user inputs from the user;
(c) means for creating a query based on the domain model and the one or more user inputs;
(d) means for transmitting the query to the information system for processing; and
(e) means for receiving one or more query results from the information system, the one or more query results corresponding to the query.

12. The user interface of claim 11, further comprising:
(a) means for authenticating the user for logging on the information system; and
(b) means for displaying the one or more query results.

13. The user interface of claim 11, wherein the domain model has a plurality of classes and one or more relations among the plurality of classes, and wherein each of the plurality of classes has one or more attributes.

14. A user interface for facilitating interaction between a user and an information system, the user interface comprising:
(a) means for retrieving a domain model from the information system, wherein the domain model has a plurality of classes;
(b) means for selecting an input class from the plurality of classes, the input class having one or more attributes;
(c) means for assigning one or more values to the one or more attributes;
(d) means for creating a first query from the one or more attributes and the one or more values;
(e) means for submitting the first query to the information system for processing;
(f) means for receiving a first set of query results from the information system, the first set of query results corresponding to the first query; and
(g) means for displaying the first set of query results.

15. A computer program product for facilitating interaction between a user and an information system, the computer program product having a medium with a computer program embodied thereon, the computer program comprising:
(a) computer program code for retrieving a domain model from the information system;
(b) computer program code for receiving one or more user inputs from the user;
(c) computer program code for creating a query based on the domain model and the one or more user inputs;
(d) computer program code for transmitting the query to the information system for processing;
(e) computer program code for receiving one or more query results from the information system, the one or more query results corresponding to the query; and
(f) computer program code for displaying the one or more query results.

16. The computer program product of claim 14, the computer program further comprising:
(a) computer program code for authenticating the user for logging on the information system; and
(b) computer program code for displaying the one or more query results.

17. The computer program product of claim 14, wherein the domain model has a plurality of classes and one or more relations among the plurality of classes, and wherein each of the plurality of classes has one or more attributes.

18. A computer program product for facilitating interaction between a user and an information system, the computer program product having a medium with a computer program embodied thereon, the computer program comprising:
(a) computer program code for retrieving a domain model from the information system, wherein the domain model has a plurality of classes;
(b) computer program code for selecting an input class from the plurality of classes, the input class having one or more attributes;
(c) computer program code for assigning one or more values to the one or more attributes;
(d) computer program code for creating a first query from the one or more attributes and the one or more values;
(e) computer program code for submitting the first query to the information system for processing;
(f) computer program code for receiving a first set of query results from the information system, the first set of query results corresponding to the first query; and
(g) computer program code for displaying the first set of query results.
